(19) United States
(12) Patent Application Publication
(10) Pub. No.: US 2008/0079237 A1
(43) Pub. Date: Apr. 3, 2008

(54) Methods and apparatus for stabilizing tractor-trailers against jackknifing

(76) Inventor: David Rubin, Tampa, FL (US)

Correspondence Address: BUCHANAN, INGERSOLL & ROONEY PC, POST OFFICE BOX 1404, ALEXANDRIA, VA, 22313-1404, US

(21) Appl. No.: 11/541,680

(22) Filed: Oct. 3, 2006

(51) Int. Cl. B62D 53/06

(52) U.S. Cl. 280/432

(57) ABSTRACT

For stabilizing a tractor and/or a trailer of a tractor-trailer unit against jackknifing, the tractor and/or trailer carries a gyroscopic mass which spins about a horizontal first axis. The tractor and/or trailer is operably uncoupled from the mass during a non-jackknifing of the tractor and/or trailer to permit free relative swiveling between the spinning mass and the tractor and/or trailer about a vertical second axis. Such relative movement can be prevented during a jackknifing state wherein a precessing of the spinning mass occurs about a horizontal third axis oriented perpendicular to the first axis and produces a torque that is transmitted to the jackknifing component for opposing the jackknifing motion thereof.

### BACKGROUND

This disclosure relates to the stabilization of the tractor and/or trailer components of an articulated tractor-trailer unit against jackknifing.

The traffic accidents involving a commercial tractor-trailer can be much more catastrophic than an ordinary car accident. A typical fully-loaded large commercial truck can weigh 80,000 pounds or more, while an average passenger automobile weighs approximately 3000 pounds. Because of this size disparity, and due to the basic laws of physics, any collision between a commercial truck and other vehicle is likely to result in serious, even fatal, injuries.

There are several factors involved in tractor-trailer accidents. The size and weight of the truck make it less maneuverable and harder to stop in an emergency. According to the IIHS, loaded tractor-trailers take 20-40 percent farther than cars to stop, and the discrepancy is even greater when trucks are carrying a heavy load. Braking ability is another factor in tractor-trailer accidents.

On wet and slippery roads, the stopping distance disparity is even worse. Tractor-trailer combinations also have the potential for loss of control and jackknifing of the trailer or the tractor on both dry and, especially, slippery roads. Jackknifing of a trailer occurs when the rear wheels of the tractor lock up, allowing the tractor to skid and spin so that it folds into the trailer. This also can happen when trailer wheels lock and cause the trailer to swing around the tractor. Under certain conditions, the tractor itself can jackknife.

Antilock brakes (ABS), which are required on all new trailers, help drivers maintain control and resist skidding during hard braking. However, anti-lock brakes are less effective on wet and slippery roads than on dry roads. Also, it is possible to jackknife a vehicle without locking the rear wheels. A “power jackknife” is one where so much power is applied to the drive-axles of the tractor that the wheels spin. This has the same effect as locking the rear wheels since a spinning tire has the same property as a locked tire, i.e., it cannot generate substantial side force.

It is also possible to jackknife a vehicle without applying the brakes or engine power. If the driver enters a curve too fast and then releases the throttle, engine braking is enough to cause some rotational slip (although not lockup) at the rear wheels. Any amount of tire slippage will reduce the side force capability of the tire. If the vehicle is going too fast, there will not be enough tire side force at the rear to balance the centrifugal force, and the vehicle will jackknife.

It will thus be appreciated that a need exists for a system capable of effectively controlling the stability of a tractor-trailer unit, especially for preventing jackknifing.

As used herein, the term “jackknifing” is intended to be generic to all types of undesired tractor or trailer swing, e.g., wherein the back end of the trailer swings out to the right or left and approaches the tractor, or the tractor itself swings.

### SUMMARY

Disclosed hereafter is a preferred tractor-trailer unit comprising a tractor, a trailer articulated thereto, and a gyroscopic stabilizing mechanism for stabilizing the tractor-trailer unit in the event of jackknifing. The stabilizing mechanism comprises a support structure carried by the tractor component and/or the trailer component of the tractor-trailer unit, a spinning mass mounted on the support structure, and a stabilization-activating mechanism actuable during jackknifing of one of the tractor/trailer components for interlocking the component and the support structure in a manner causing the spinning mass to precess and transmit to the component a torque opposing the jackknifing thereof.

In the preferred embodiment, the gyroscopic stabilizing mechanism is actuable from a non-activated state to an activated state to stabilize the tractor-trailer unit. The stabilizing mechanism is carried by the tractor and/or the trailer and comprises a first support member, and a gyroscopic mass mounted on the first support member for rotation about a substantially horizontal first axis. A motor is operably connected to the mass for rotating the mass about the first axis. A second support member is mounted to the at least one component for relative swiveling about a substantially vertical second axis. The first support member is carried by the second support member for rotation relative thereto about a substantially horizontal third axis extending substantially perpendicularly to the first axis. The at least one unit and the second support member are freely swivelable relative to one another about the second axis in the non-activated state of the stabilizing mechanism. The stabilizing mechanism includes an activating mechanism which is actuable during jackknifing of the tractor component or the trailer component for at least partially interlocking the jackknifing component and the second support member against such relative swiveling about the second axis. Accordingly, as the jackknifing component swings, it tends to turn the spinning mass out of the plane in which it is spinning, an action resisted by the mass such that the mass precesses and produces a torque that is transmitted to the jackknifing component to oppose the jackknifing motion thereof.

Also disclosed is a method of stabilizing an articulated tractor-trailer unit wherein a front end of a trailer component is articulated to a tractor component. The method comprises the steps of:

A. providing a gyroscopic stabilizing mechanism for stabilizing the trailer in the event of jackknifing, comprising a support structure carried by at least one of the tractor component and the trailer component, a spinning mass mounted on the support structure, and a stabilization activation mechanism; and

B. actuating the stabilization activation mechanism during jackknifing in a manner causing the spinning mass to precess and transit to the at least one component a torque opposing the jackknifing.

Another preferred method of stabilizing an articulated tractor-trailer unit comprises the steps of:

A. continuously spinning a gyroscopic mass carried by at least one of the tractor component and the trailer component of the unit, the mass spinning about a substantially horizontal first axis;

B. maintaining the at least one component and the spinning mass operably uncoupled from one another during a non-jackknifing state to permit relative swiveling between the spinning mass and the at least one component about a substantially vertical second axis;

C. at least partially interlocking the at least one component and the rotating mass against such free swiveling about the second axis during a jackknifing state, wherein the swinging motion of the jackknifing component tends to displace the axis of the spinning mass out of the fore-aft direction, thereby causing the mass to precess about a substantially horizontal third axis oriented substantially perpendicular to the first axis; and

D. transmitting to the jackknifing component a torque produced by the precessing mass, for opposing the jackknifing motion thereof.

### BRIEF DESCRIPTION OF THE DRAWINGS

Depicted in the appended drawings is a detailed description of a preferred embodiment wherein like numerals designate like elements.

FIG. 1 is a plan view of a tractor trailer carrying the disclosed stabilizing mechanism.

FIG. 2 is a view similar to FIG. 1 showing the tractor trailer undergoing a jackknifing motion.

FIG. 3 is a view of the stabilizing mechanism as seen in the direction of arrow D1 in FIG. 1.

FIG. 4 is a view of the stabilizing mechanism as seen in the direction D2 in FIG. 1.

FIG. 5 is a sectional view through the stabilizing mechanism.

FIG. 6 is a rear perspective view of the trailer showing the stabilizing mechanism.

### DESCRIPTION OF A PREFERRED EMBODIMENT

In accordance with a preferred embodiment, a tractor component and/or a trailer component of a tractor-trailer unit is provided with a spinning gyroscope which is actuable to become operably coupled to a jackknifing component in the early stage of a jackknifing action to effectively stabilize the jackknifing component. It is common knowledge that a rapidly spinning gyroscopic mass resists efforts to turn it out of its plane of rotation. Stated differently, a spinning gyro wheel resists any force that tends to change the direction of its axis of spin. That resistance, known as the gyroscopic reaction moment (GRM), is a reaction against the bearings and supports of the gyroscope mass. It is an inertial reaction (gyroscopic inertia) stemming from the law of conservation of momentum that gives gyroscopes their practical usefulness.

In accordance with the disclosed embodiment, a spinning gyro mass is connected to the tractor component and/or the trailer component of a tractor-trailer unit by a swivel connection normally allowing free swiveling movement between the component(s) and the spinning mass about a substantially vertical axis, in order to prevent the mass from turning out of the plane in which it is spinning as the tractor-trailer unit traverses curves. Under a jackknifing condition, however, the swivel connection can be at least partially locked, whereby the gyroscopic reaction moment causes the spinning mass to precess and generate a torque which is transferred to the jackknifing component to oppose the jackknifing motion.

Depicted schematically in FIG. 1 is a tractor-trailer unit 10 comprised of a tractor component 12 and a trailer component 14 connected thereto for pivoting movement about a vertical pivot axis, or fifth wheel 16.

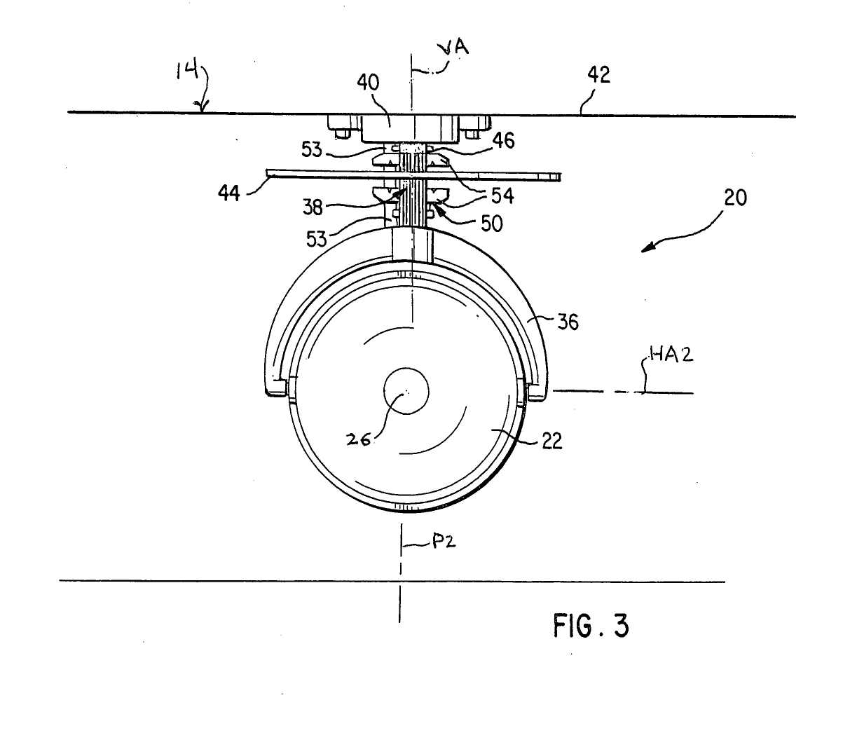

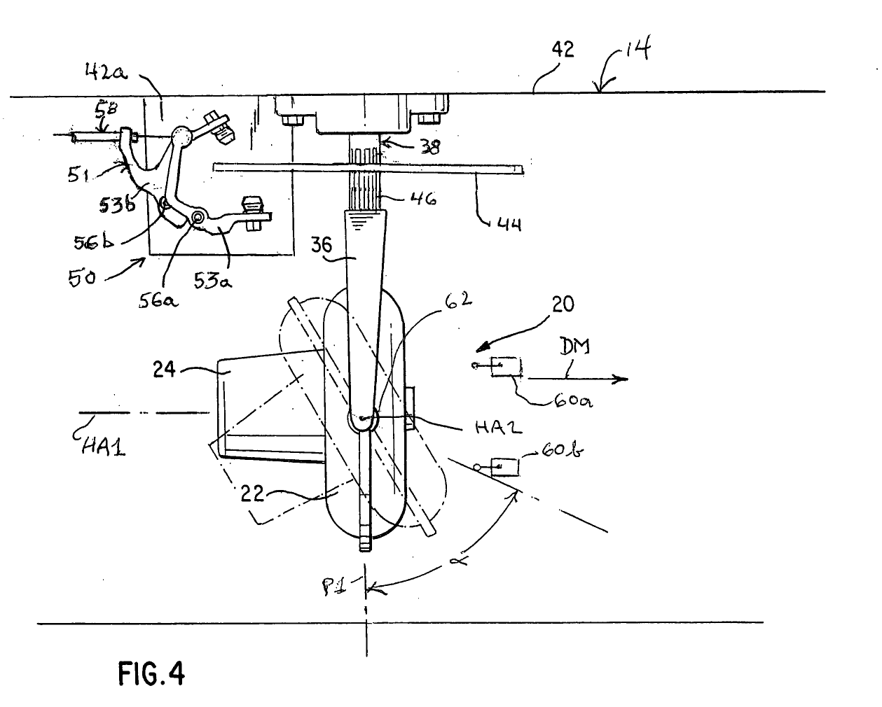

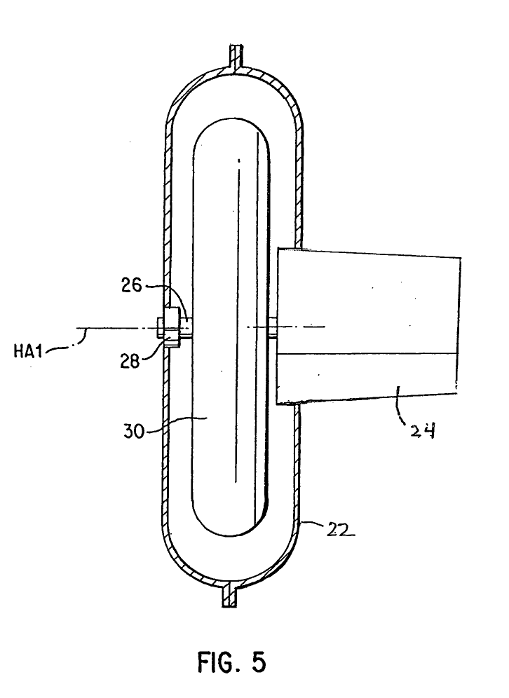

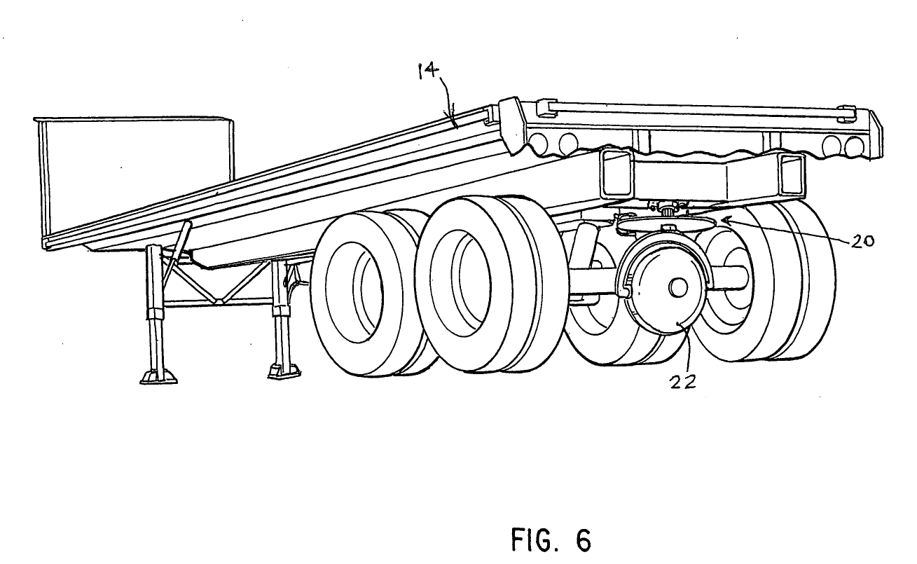

Shown in FIGS. 3-6 is a stabilizing mechanism 20 carried by the trailer 14 for preventing or minimizing a jackknifing action of the trailer. It will be appreciated, however, that an identical mechanism 20 could alternatively or additionally carried by the tractor (as shown in FIG. 1). The direction of vehicle movement DM is toward the viewer in FIG. 3, and in the direction of the arrow DM in FIGS. 4 and 5. The stabilizing mechanism 20 comprises a first support member 22 to which a motor 24, such as an electric D.C. motor powered by the tractor's electrical system, is attached. Rotatably mounted in the first support member 22 is a horizontal drive shaft 26, one end of which is rotatably mounted in a bearing 28 carried by the first support member 22, and an opposite end of which is driven by the motor. A gyroscopic mass 30 in the form of a wheel is affixed to the drive shaft 26 for rotation therewith. Thus, the motor can spin the mass 30 about a first horizontal axis HA1 defined by the drive shaft 26 and oriented parallel to the front-to-rear longitudinal axis of the trailer 14. During normal forward vehicle travel, the mass spins within a plane P1 oriented perpendicular to the intended direction of travel D.

The first support member 22 is attached to a yoke-shaped second support member 36 for pivotal movement relative thereto about a second horizontal axis HA2 (i.e., a precession axis) which perpendicularly intersects the first horizontal axis HA1.

The spin axis HA1 is shown as horizontal and parallel to the direction of vehicle travel. However, it is only required that the axis be horizontal (or substantially horizontal).

The second support member 36 includes a vertical mounting shaft 38, a free end of which is swivelable about a vertical axis VA defined by the mounting shaft, which is mounted to swivel in a bearing 40 that is fixed on a frame 42 of the trailer 14. The second support member 36 also includes a disc 44 arranged on the mounting shaft so as to be non-rotatable relative thereto. For example, the disc could be connected to the mounting shaft 38 by splines 46 as shown, or otherwise fixed to the mounting shaft.

Carried by the trailer frame 42 is a brake mechanism 50 preferably including a clamp 51 for clamping against the disc 44 to resist relative swiveling between the mounting shaft 38 and the trailer frame about the vertical axis VA. The brake mechanism can take any suitable form, such as the dual pivot caliper brake device shown in FIGS. 3 and 4. That brake device includes a pair of legs 53a, 53b each connected to a portion 42a of the trailer frame by a respective pivot 56a, 56b and carrying a brake pad 54. The disc 44 is disposed between the brake pads so that when a force is applied to one of the legs 53a, e.g., by a standard cable device 58, causing the leg 53a to pivot counterclockwise about the pivot 56a, and the leg 53b to pivot clockwise about the pivot 56b, the brake pads will be swung toward the disk 44 to apply a frictional clamping (braking) force thereto. The magnitude of the clamping force is proportional to the magnitude of the actuating force from the cable device, so the disc 44 can be either partially or completely prevented from swiveling about the vertical axis VA. The actuating force could be a manual force applied by a driver using a hand lever or foot lever, for instance, or it could be mechanically generated by a computer-controlled mechanism.

In operation, the brake 50 mechanism is normally deactivated to enable free relative swiveling between the support member 36 and the trailer 14 about the vertical axis VA. The motor continuously spins the drive shaft 26 and the mass 30 about the horizontal axis HA1. During normal travel of the trailer, the shaft 38, the first and second support members, the mass 30 and the motor 24 are free to swivel freely as a unit about the vertical axis VA.

However, if jackknifing is sensed, e.g., by the driver, the driver can apply a force to the cable device 58, whereupon the brake mechanism 50 will apply a frictional braking force to the disc 44, causing the mounting shaft 38 to become partially or completely locked to the trailer. Thereafter, continued swinging-out of the trailer will tend to turn the brake mechanism, and thus the spinning mass 30, about the articulation axis of the fifth wheel 16, and out of the plane P1.

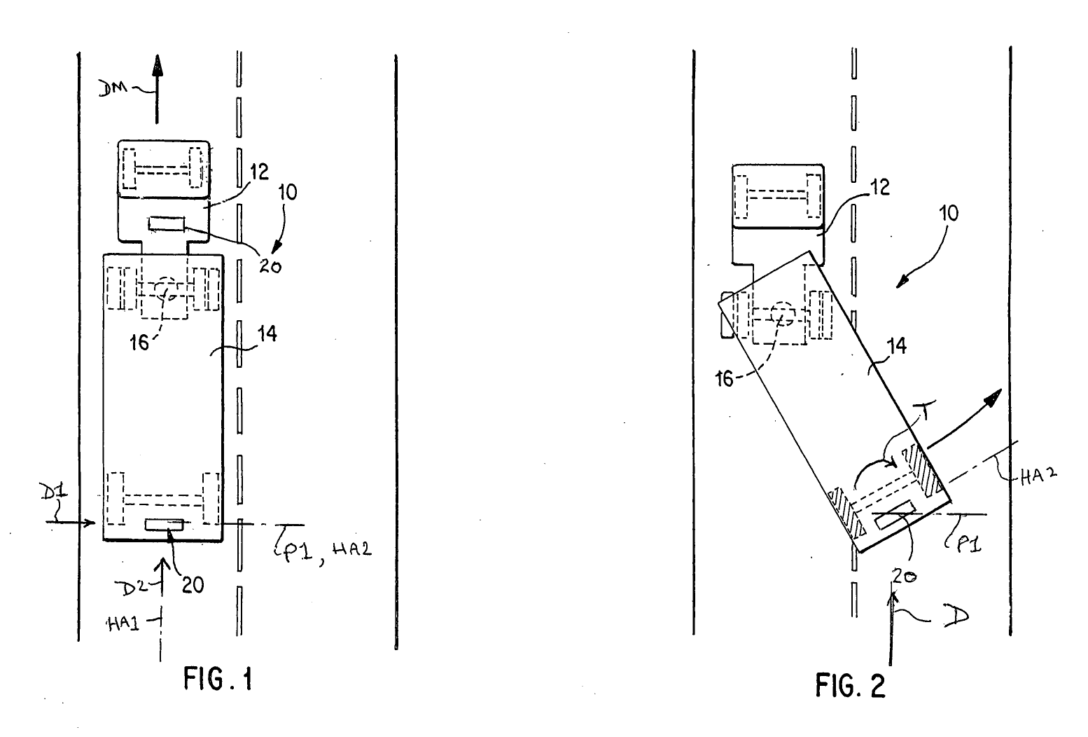

In other words, the swinging-out of the trailer about the vertical axis of the fifth wheel 16, which tends to change the direction of the trailer's longitudinal axis, tends to cause the mounting shaft 38 to be swung about the vertical axis of the fifth wheel, thus tending to turn the spinning mass 30 out of the plane P1 and change the direction of the spin axis HA1 (due to the mounting shaft 38 being at least partially locked to the trailer). However, in response to that action, a gyroscopic reaction moment is generated by the precessing spinning mass to resist such effort to turn it out of the plane P1. Due to that fact, and the fact that free relative swiveling between the trailer and the stabilizing mechanism 20 about the axis VA is no longer possible (assuming a complete locking of the mounting shaft 38 by the brake mechanism), the precessing of the mass about the axis HA2 results in the creation of a torque T (FIG. 2) which is applied to the trailer through the mounting shaft 38 and the brake mechanism 50 in a clockwise direction for resisting the counterclockwise swinging-out motion of the trailer.

During the precessing of the mass, the front end of the drive shaft 26 of the gyro will swing either up or down, depending upon the direction (i.e., left or right) in which the trailer is swinging out.

The magnitude of the torque T (GRM) which opposes the swinging-out of the trailer is a function of at least the weight and spinning speed of the mass and the strength of the braking force. If the mass and the spinning speed are great enough relative to the trailer's angular momentum, the swinging-out of the trailer could be completely stopped by fully applying the brake.

In some instances, e.g., if jackknifing occurs as the tractor-trailer unit is traversing a curve, it may be desirable to only partially lock the trailer to the stabilizing mechanism so that the jackknifing can be controlled while still enabling the trailer to safely follow the tractor around the curve.

Generally speaking, it is desirable that the mass 30 weigh roughly about one percent of the weight of a fully-loaded trailer. For example, in the case of a loaded trailer weighing 80,000 pounds, the mass 30 could weight 600-800 pounds. The speed of the mass could be generally in the range of about 1,000-2,000 rpm.

An additional benefit of the invention is realized in the event that the trailer or tractor begins to roll over as jackknifing occurs. In that event, the GRM generated by the gyro in response to the jackknifing will become directed to oppose the rolling action, because as jackknifing and rolling simultaneously occur, the axis of spin HA1 will be shifted out of a horizontal state. The greater the shifting of the axis HA1 out of horizontal, the greater will be the resistance to roll-over.

Gyroscopes have been previously mounted on large vessels, such as ships, for stabilizing the vessel against pitch or yawing. However, in accordance with the present embodiment, a gyroscope is mounted on a tractor-trailer unit and is selectively lockable thereto, so that the stabilization action occurs only when needed and will not interfere with articulation during normal operation.

The stabilizing mechanism can be mounted at any location on the tractor and or the trailer, i.e., when on the trailer it can be close to or remote from the fifth wheel, or even at the fifth wheel wherein the axis VA would coincide with the vertical axis of the fifth wheel.

It will be appreciated that numerous modifications of the disclosed preferred embodiment are possible. As pointed out above, in order to stop the jackknifing, the inertia mass must precess. This precession creates the GRM. As the inertial mass precesses toward a ninety degree angle (i.e., as the axis HA1 moves through a ninety degree angle from a horizontal state to a vertical state), its effectiveness is reduced by the cosine of the angle. Therefore, after the jackknifing is stopped, the inertia mass should be restored to its upright position, or ready position, to be fully effective for the next jackknifing event. This optional feature can be accomplished with the use of sensors, e.g., limit switches 60a, 60b (FIG. 4) that are operably connected to the motor 24. Once the inertia mass has precessed through a specified angle a up to 90 ninety degrees (e.g., through 65 degrees), either the limit switch 60a or 60b (depending on the direction of precessing), is actuated to open the circuit to the motor 24, allowing the mass to slow to a stop. This allows a restoring spring (e.g., a torsion spring 62 shown in FIG. 4) to restore the mass to its upright ready position without fighting the GRM. of the inertia mass. Once the mass is in its ready position, the motor re-starts to again bring the inertia mass up to speed.

Alternatively, or in addition, a low speed shut off (not shown) could be provided to deactivate the stabilizing mechanism 20 when the tractor trailer is at slow speeds and is making sharp turns (as in parking or turning into a loading ramp or preparing to back up), when jackknifing is not a concern. For example, it may be desirable to provide contact switches which function to automatically shut-off the motor 24 (thus terminating the stabilizing action) if the precession of the mass 30 exceeds a certain limit, in order to limit the maximum amount of torque that can be created by the precessing mass.

Alternatively, or in addition, a mechanism could be provided which shuts off the motor once the tractor-trailer unit has slowed below a predetermined speed of travel.

The stabilizing mechanism could be automatically actuable. For example, the brake mechanism could be operably connected to a control mechanism which determines from various sensed parameters whether jackknifing is occurring. Thus, the magnitude of the disk-braking force and the timing of disk-braking operation could be automatically controlled, eliminating the need for driver intervention.

It will be appreciated by those skilled in the art that additions, modifications, substitutions and deletions not specifically described may be made without departing from the spirit and scope of the invention as defined by the appended claims.

What is claimed is:

1. A tractor-trailer unit comprising:
a tractor component;
a trailer component having a front end articulated to the tractor component, and
a gyroscopic stabilizing mechanism carried by at least one of the tractor component and the trailer component for stabilizing the at least one component in the event of jackknifing thereof, comprising a support structure, a spinning mass mounted on the subject structure, and a stabilization-activating mechanism actuable during jackknifing for interlocking the at least one component and the support structure in a manner causing the spinning mass to precess and transmit to the at least one component a torque opposing the jackknifing thereof.

2. A tractor-trailer unit comprising:
a tractor component;
a trailer having a front end articulated to the tractor component; and
a gyroscopic stabilizing mechanism actuable, during jackknifing of at least one of the tractor component and the trailer component, from a non-activated state to an activated state to stabilize the at least one component, the stabilizing mechanism carried by the at least one component and comprising:
a first support member,
a gyroscopic mass mounted on the first support member for rotation about a substantially horizontal first axis,
a motor operably connected to the mass for spinning the mass about the first axis;
a second support member mounted to the at least one component for relative swiveling movement about a substantially vertical second axis, the first support member being carried by the second support member for rotation relative thereto about a substantially horizontal third axis extending substantially perpendicular to the first axis, the at least one component and the second support member being freely swivelable relative to one another about the second axis in the non-activated state of the stabilizing mechanism, and
a stabilization-activating mechanism actuable during jackknifing of the at least one component for at least partially interlocking the trailer and the second support member against relative swiveling about the second axis, wherein the spinning gyroscopic mass precesses about the third axis and generates a torque transmitted to the at least one component to oppose the jackknifing motion thereof.

3. The tractor-trailer unit according to claim 2 wherein the motor comprises an electric D.C. motor.

4. The tractor-trailer unit according to claim 2 wherein the motor is mounted on the first support member.

5. The tractor-trailer unit according to claim 2 wherein the second support member is fixed to a mounting shaft for mounting the second support member to the at least one component and for defining the second axis; the stabilization-activation mechanism comprising a disc arranged for rotation with the mounting shaft, and a brake mechanism carried by the at least one component and clampable against the disc.

6. The tractor-trailer unit according to claim 2 wherein the first and third axes intersect one another perpendicularly.

7. The tractor-trailer unit according to claim 2 wherein the stabilizing mechanism is mounted on the trailer.

8. The tractor-trailer unit according to claim 7 wherein the stabilizing mechanism is mounted on the tractor.

9. The tractor-trailer unit according to claim 2 wherein another such stabilizing mechanism is mounted on the trailer.

10. The tractor-trailer unit according to claim 2 wherein the stabilization-activation mechanism is manually actuable.

11. The tractor-trailer unit according to claim 2 wherein the first support member comprises a housing enclosing the mass, and the second support member comprises a yoke having a pair of spaced apart arms; the first support member disposed between the arms and pivotably connected thereto to define the third axis.

12. The tractor-trailer unit according to claim 2 further including a sensor actuable in response to precessing of the mass through a predetermined angle for shutting down the motor to enable the spinning speed of the mass to be substantially reduced.

13. The tractor-trailer unit according to claim 12 including a spring mechanism for returning the mass to an upright ready position in response to the reduction in spinning speed.

14. A method of stabilizing at least one of a tractor component and a trailer component of a tractor-trailer unit wherein a front end of the trailer component is articulated to the tractor component, the method comprising the steps of:
A. providing a gyroscopic stabilizing mechanism for stabilizing the at least one component in the event of jackknifing thereof, comprising a support structure carried by the at least one component, a spinning mass mounted on the support structure, and a stabilization activation mechanism; and
B. actuating the stabilization activation mechanism during jackknifing of the at least one component in a manner causing the spinning mass to precess and transmit to the at least one component a torque opposing the jackknifing thereof.

15. A method of stabilizing at least one of a tractor component and a trailer component of a tractor-trailer unit wherein a front end of the trailer component is articulated to the tractor component, the method comprising the steps of:
A. continuously spinning a gyroscopic mass carried by the at least one component, the mass spinning about a substantially horizontal first axis;
B. maintaining the trailer and the spinning mass operably uncoupled from one another during a non-jackknifing state of the at least one component to permit relative swiveling between the spinning mass and the at least one component about a substantially vertical second axis;
C. at least partially interlocking the at least one component and the rotating mass during a jackknifing state of the at least one component, wherein the swinging motion of the jackknifing component tends to displace the axis of the spinning mass, causing the mass to precess about a substantially horizontal third axis oriented substantially perpendicular to the first axis; and
D. transmitting to the at least one component a torque produced by the precessing mass, for opposing the jackknifing motion thereof.

16. The method according to claim 15 wherein the free swiveling movement between the spinning mass and the at least one component during step B is at least partially prevented during steps C and D.

17. The method according to claim 15 further including the step of substantially reducing the spinning speed of the mass in response to precessing of the mass through a predetermined angle.

18. The method according to claim 17 including returning the mass to an upright ready position by a return spring force in response to the reduction in spinning speed.
